(19) United States
(12) Patent Application Publication
(10) Pub. No.: US 2015/0198779 A1
(43) Pub. Date: Jul. 16, 2015

(54) IMAGING LENS AND SPACER ADAPTED TO IMAGING LENS

(71) Applicants: Hung-Chang Cho, Taichung City (TW); Yiman Deng, Xiamen (CN); Weiwei Fu, Xiamen (CN); Haibin Zhan, Xiamen (CN); Zhihong Xu, Xiamen (CN)

(72) Inventors: Hung-Chang Cho, Taichung City (TW); Yiman Deng, Xiamen (CN); Weiwei Fu, Xiamen (CN); Haibin Zhan, Xiamen (CN); Zhihong Xu, Xiamen (CN)

(21) Appl. No.: 14/667,694

(22) Filed: Mar. 25, 2015

Related U.S. Application Data
(63) Continuation of application No. 14/067,978, filed on Oct. 31, 2013.

(30) Foreign Application Priority Data
Jul. 17, 2013 (CN) 201310299417.8

(51) Int. Cl. G02B 7/02; G02B 1/04; G02B 1/11

(52) U.S. Cl. CPC G02B 7/021; G02B 1/11; G02B 1/04; G02B 7/026

(57) ABSTRACT

An imaging lens includes a lens barrel, a plurality of lens elements and a spacer. The lens elements are disposed in the lens barrel. The spacer is disposed between the lens barrel and one of the lens elements or between two adjacent lens elements. The spacer is ring-shaped and includes an inside layer and two outside layers. The two outside layers are attached on opposite sides of the inside layer, respectively. The spacer has an object-side surface, an image-side surface and a first inner ring-shaped oblique surface. The object-side surface and the image-side surface are formed outside the two outside layers in parallel and oriented toward an object side and an image side of the lens elements, respectively. The first inner ring-shaped oblique surface is formed at an inner periphery of the spacer and connected to at least one of the object-side surface and the image-side surface.

### CROSS REFERENCE TO RELATED APPLICATIONS

This is a Continuation application of Ser. No. 14/067,978, now pending, filed on Oct. 31, 2013.

### BACKGROUND OF THE INVENTION

1. Field of the Invention

The invention relates to an imaging lens and, more particularly, to a spacer adapted to an imaging lens.

2. Description of the Prior Art

An imaging is a quite important optical component in a mobile electronic device or a camera and the optical property of the imaging lens determines the quality of an image. In general, the imaging lens essentially comprises a lens barrel, a plurality of lens elements and a plurality of spacers. The lens elements are disposed in the lens barrel. The spacer may be disposed between the lens barrel and one of the lens elements or between two adjacent lens elements. When light emitted or reflected by an object, which is located at an object side of the imaging lens, enters the lens barrel, it forms an image on an imaging plane at an image side of the imaging lens after passing through the lens elements. However, since the spacer has a specific thickness, stray light may be reflected by an inner periphery of the spacer and then received by the imaging plane, such that flare or ghost phenomenon may occur.

### SUMMARY OF THE INVENTION

The invention relates to an imaging lens and a spacer adapted to an imaging lens, so as to solve the aforesaid problems.

According to an embodiment of the invention, an imaging lens comprises a lens barrel, a plurality of lens elements and a spacer. The lens elements are disposed in the lens barrel. The spacer is disposed between the lens barrel and one of the lens elements or between two adjacent lens elements. The spacer is ring-shaped and comprises an inside layer and two outside layers. The two outside layers are attached on opposite sides of the inside layer, respectively. The spacer has an object-side surface, an image-side surface and a first inner ring-shaped oblique surface. The object-side surface and the image-side surface are formed outside the two outside layers in parallel and oriented toward an object side and an image side of the lens elements, respectively. The first inner ring-shaped oblique surface is formed at an inner periphery of the spacer and connected to at least one of the object-side surface and the image-side surface. An anti-reflection capability of each outside layer is better than an anti-reflection capability of the inside layer.

According to another embodiment of the invention, a spacer adapted to an imaging lens comprises an inside layer and two outside layers. The inside layer is ring-shaped. The two outside layers are ring-shaped and attached on opposite sides of the inside layer, respectively. The spacer has an object-side surface, an image-side surface and a first inner ring-shaped oblique surface. The object-side surface and the image-side surface are formed outside the two outside layers in parallel and oriented toward an object side and an image side of the lens elements, respectively. The first inner ring-shaped oblique surface is formed at an inner periphery of the spacer and connected to at least one of the object-side surface and the image-side surface. An anti-reflection capability of each outside layer is better than an anti-reflection capability of the inside layer.

As mentioned in the above, the invention attaches two outside layers with better anti-reflection capability on opposite sides of the inside layer, respectively, so as to form a three-layer spacer, and forms the inner ring-shaped oblique surface at the inner periphery of the three-layer spacer. When light emitted or reflected by an object, which is located at the object side of the imaging lens, enters the lens barrel, the two outside layers and the inner ring-shaped oblique surface can restrain the light from being reflected by the inner periphery of the spacer effectively, so as to avoid the occurrence of flare or ghost phenomenon.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional view illustrating an imaging lens according to a first embodiment of the invention.

FIG. 2 is a cross-sectional view illustrating the spacer shown in FIG. 1.

FIG. 3 is a cross-sectional view illustrating a spacer according to a second embodiment of the invention.

FIG. 4 is a cross-sectional view illustrating a spacer according to a third embodiment of the invention.

FIG. 5 is a cross-sectional view illustrating a spacer according to a fourth embodiment of the invention.

FIG. 6 is a cross-sectional view illustrating a spacer according to a fifth embodiment of the invention.

FIG. 7 is a cross-sectional view illustrating a spacer according to a sixth embodiment of the invention.

### DETAILED DESCRIPTION

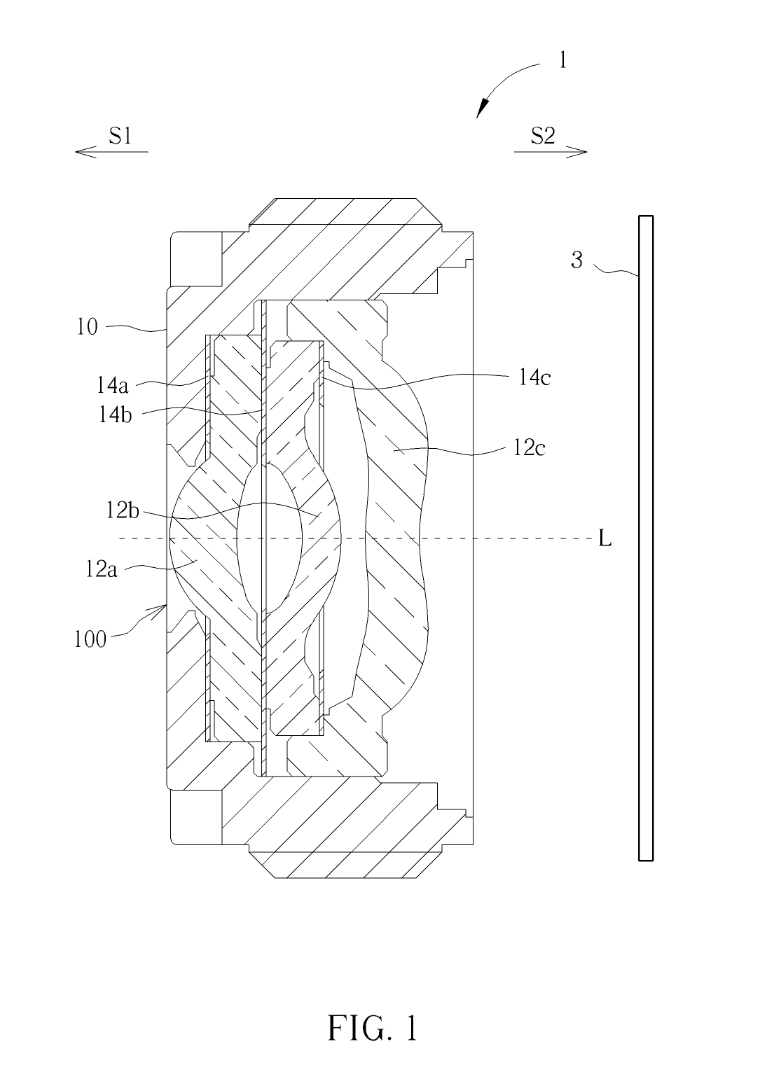

Referring to FIG. 1, FIG. 1 is a cross-sectional view illustrating an imaging lens 1 according to a first embodiment of the invention. As shown in FIG. 1, the imaging lens 1 comprises a lens barrel 10, a plurality of lens elements 12a, 12b, 12c and a plurality of spacers 14a, 14b, 14c. In this embodiment, the imaging lens 1 comprises three lens elements 12a, 12b, 12c and three spacers 14a, 14b, 14c. The lens elements 12a, 12b, 12c and the spacers 14a, 14b, 14c all are disposed in the lens barrel 10. The lens barrel 10 has a light incident hole 100 formed at an object side S1. The spacers 14a, 14b, 14c all are ring-shaped, wherein the spacer 14a is disposed between an inner wall of the light incident hole 100 of the lens barrel 10 and the lens element 12a, the spacer 14b is disposed between two adjacent lens elements 12a, 12b, and the spacer 14c is disposed between two adjacent lens elements 12b, 12c. In other words, the spacer of the invention may be disposed between the lens barrel 10 and one of the lens elements 12a, 12b, 12c or between two adjacent lens elements of the lens elements 12a, 12b, 12c. It should be noted that the number and position of the lens elements and spacers can be determined according to practical applications, so they are not limited to the embodiment shown in FIG. 1.

The imaging lens 1 may be applied to a camera module of a portable electronic device (e.g. mobile phone, tablet computer, notebook computer, etc.), a traditional camera, or a digital camera. In this embodiment, opposite sides of the imaging lens 1 may be defined as an object side S1 and an image side S2, and an imaging plane 3 may be disposed at the image side S2. Furthermore, the lens elements 12a, 12b, 12c have an optical axis L. When light emitted or reflected by an object (not shown), which is located at the object side S1 of the imaging lens 1, enters the lens barrel 10 along the optical axis L, it forms an image on the imaging plane 3 at the image side S2 of the imaging lens 1 after passing through the lens elements 12a, 12b, 12c. In practical applications, the image plane 3 may be a charge-coupled device (CCD) sensor or a complementary metal-oxide semiconductor (CMOS) sensor.

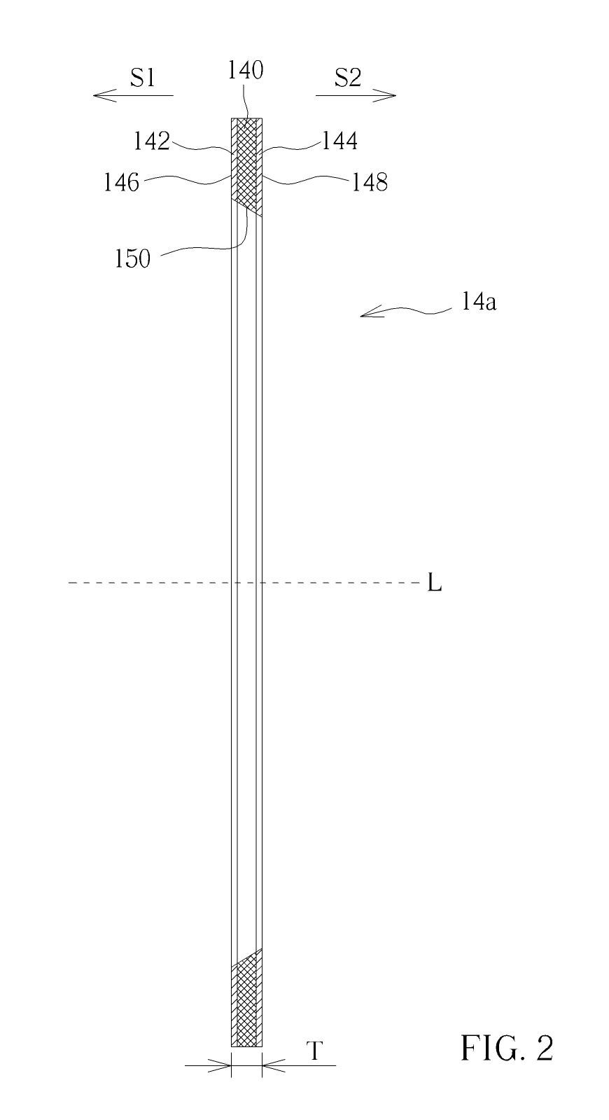

Referring to FIG. 2, FIG. 2 is a cross-sectional view illustrating the spacer 14a shown in FIG. 1. As shown in FIG. 2, the spacer 14a comprises an inside layer 140 and two outside layers 142, 144. The two outside layers 142, 144 are attached on opposite sides of the inside layer 140, respectively, so as to form the three-layer spacer 14a. Furthermore, the spacer 14a has an object-side surface 146, an image-side surface 148 and a first inner ring-shaped oblique surface 150. The object-side surface 146 and the image-side surface 148 are formed outside the two outside layers 142, 144 in parallel and oriented toward the object side S1 and the image side S2 of the lens elements 12a, 12b, 12c, respectively. The first inner ring-shaped oblique surface 150 is formed at an inner periphery of the spacer 14a and connected to the object-side surface 146 and the image-side surface 148, wherein an internal diameter of the spacer 14a increases gradually along the first inner ring-shaped oblique surface 150 from the image side S2 to the object side S1, such that a thickness T of the spacer 14a at the first inner ring-shaped oblique surface 150 decreases gradually toward the optical axis L of the lens elements 12a, 12b, 12c. In this embodiment, the first inner ring-shaped oblique surface 150 maybe formed at the inner periphery of the spacer 14a by a stamping process.

In this embodiment, an anti-reflection capability of each outside layer 142, 144 is better than an anti-reflection capability of the inside layer 140. In other words, compared with the inside layer 140, each of the two outside layers 142, 144 has higher optical density (i.e. absorbance) and lower surface gloss ratio. For example, the optical density of each outside layer 142, 144 may be 4.0 and the surface gloss ratio of each outside layer 142, 144 maybe between 2% and 4% for a light incident angle of 60 degrees. The inside layer 140 may be made of a polymer material (e.g. Polyethylene terephthalate (PET), Polycarbonate (PC) or Polymethyl methacrylate(PMMA)) or a metal (e.g. leadless brass or stainless steel), and the two outside layers 142, 144 may be made of a carbon material (e.g. carbon leather). If the two outside layers 142, 144 are made of carbon leather, the carbon leather may be attached to the inside layer 140 by bonding or adhesion. Moreover, the invention may also coat or spray the carbon material onto the surface of the inside layer 140, so as to form the two outside layers 142, 144. In this embodiment, a total thickness of the spacer 14a may be between 25 μm and 80 μm, and a thickness of each outside layer 142, 144 may be between 4 μm and 15 μm.

When light emitted or reflected by an object (not shown), which is located at the object side S1 of the imaging lens 1, enters the lens barrel 10, the two outside layers 142, 144 and the inner ring-shaped oblique surface 150 can restrain the light from being reflected by the inner periphery of the spacer 14a effectively, so as to avoid the occurrence of flare or ghost phenomenon. It should be noted that the structure of each spacer 14b, 14c may be the same as that of the spacer 14a, so the spacers 14b, 14c may also avoid the occurrence of flare or ghost phenomenon.

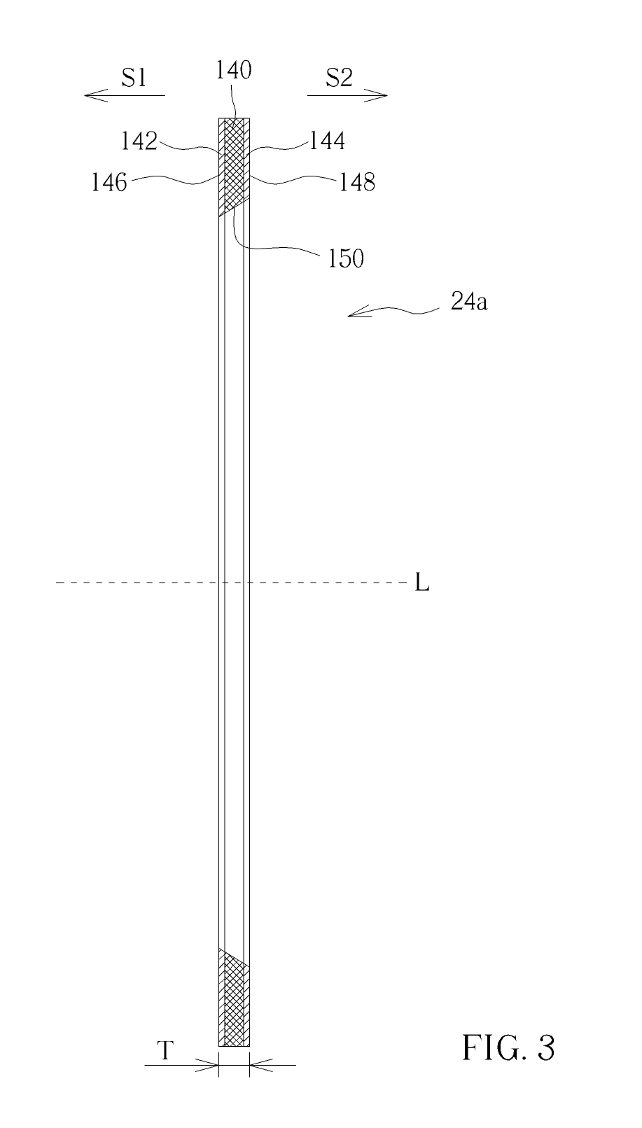

Referring to FIG. 3, FIG. 3 is a cross-sectional view illustrating a spacer 24a according to a second embodiment of the invention. The main difference between the spacer 24a and the aforesaid spacer 14a is that an internal diameter of the spacer 24a increases gradually along the first inner ring-shaped oblique surface 150 from the object side S1 to the image side S2. In other words, an inclined direction of the first inner ring-shaped oblique surface 150 of the spacer 24a is opposite to an inclined direction of the first inner ring-shaped oblique surface 150 of the spacer 14a. Compared with the spacer 14a of the aforesaid first embodiment, the spacer 24a of the second embodiment can eliminate stray light coming from different directions. Accordingly, a designer can determine to apply which type of spacer in the imaging lens according to the distribution of stray light in the imaging lens. It should be noted that the same elements in FIG. 3 and FIG. 2 are represented by the same numerals, so the repeated explanation will not be depicted herein again. Furthermore, the structure of each spacer 14b, 14c maybe the same as that of the spacer 24a according to practical applications.

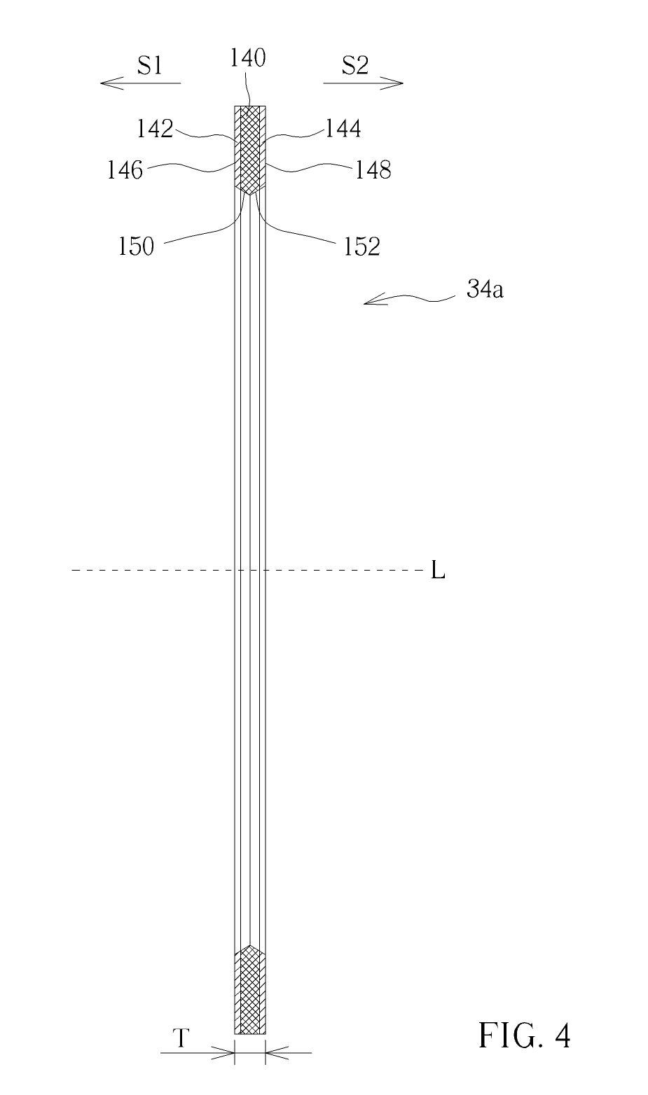

Referring to FIG. 4, FIG. 4 is a cross-sectional view illustrating a spacer 34a according to a third embodiment of the invention. The main difference between the spacer 34a and the aforesaid spacer 14a is that the spacer 34a further has a second inner ring-shaped oblique surface 152. As shown in FIG. 4, the first inner ring-shaped oblique surface 150 and the second inner ring-shaped oblique surface 152 both are formed at the inner periphery of the spacer 34a, and an inclined direction of the first inner ring-shaped oblique surface 150 is opposite to an inclined direction of the second inner ring-shaped oblique surface 152. In this embodiment, the first inner ring-shaped oblique surface 150 is connected between the object-side surface 146 and the second inner ring-shaped oblique surface 152, and the second inner ring-shaped oblique surface 152 is connected between the image-side surface 148 and the first inner ring-shaped oblique surface 150. The spacer 34a can eliminate a stray light from the object side S1 to the image side S2 and eliminate another stray light from the image side S2 to the object side S1 at the same time. It should be noted that the same elements in FIG. 4 and FIG. 2 are represented by the same numerals, so the repeated explanation will not be depicted herein again. Furthermore, the structure of each spacer 14b, 14c may be the same as that of the spacer 34a according to practical applications.

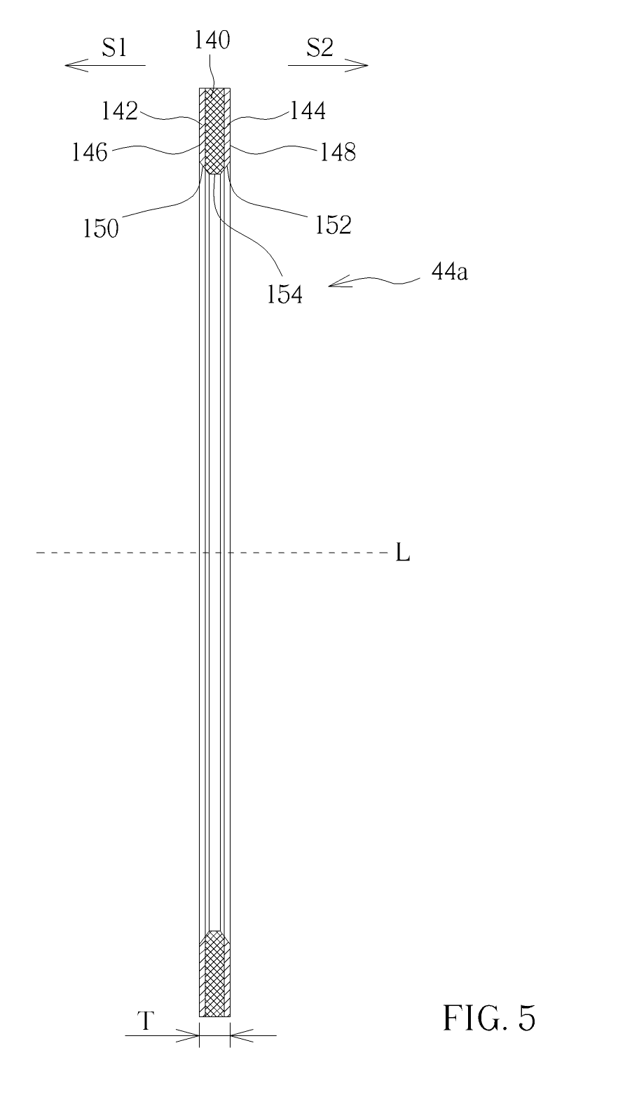

Referring to FIG. 5, FIG. 5 is a cross-sectional view illustrating a spacer 44a according to a fourth embodiment of the invention. The main difference between the spacer 44a and the aforesaid spacer 34a is that the spacer 44a further has an inner ring-shaped flat surface 154. As shown in FIG. 5, the first inner ring-shaped oblique surface 150, the second inner ring-shaped oblique surface 152 and the inner ring-shaped flat surface 154 all are formed at the inner periphery of the spacer 44a, the inner ring-shaped flat surface 154 is connected between the first inner ring-shaped oblique surface 150 and the second inner ring-shaped oblique surface 152, and the inner ring-shaped flat surface 154 is perpendicular to the object-side surface 146 and the image-side surface 148. In this embodiment, when forming the first inner ring-shaped oblique surface 150 and the second inner ring-shaped oblique surface 152 by the stamping process, the spacer 44a may be stamped by a stamping head in front of the inner ring-shaped flat surface 154, so as to prevent an inner hole of the spacer 44a from being expanded due to over-stamping and avoid influencing the optical property of the imaging lens. It should be noted that the same elements in FIG. 5 and FIG. 4 are represented by the same numerals, so the repeated explanation will not be depicted herein again. Furthermore, the structure of each spacer 14b, 14c maybe the same as that of the spacer 44a according to practical applications.

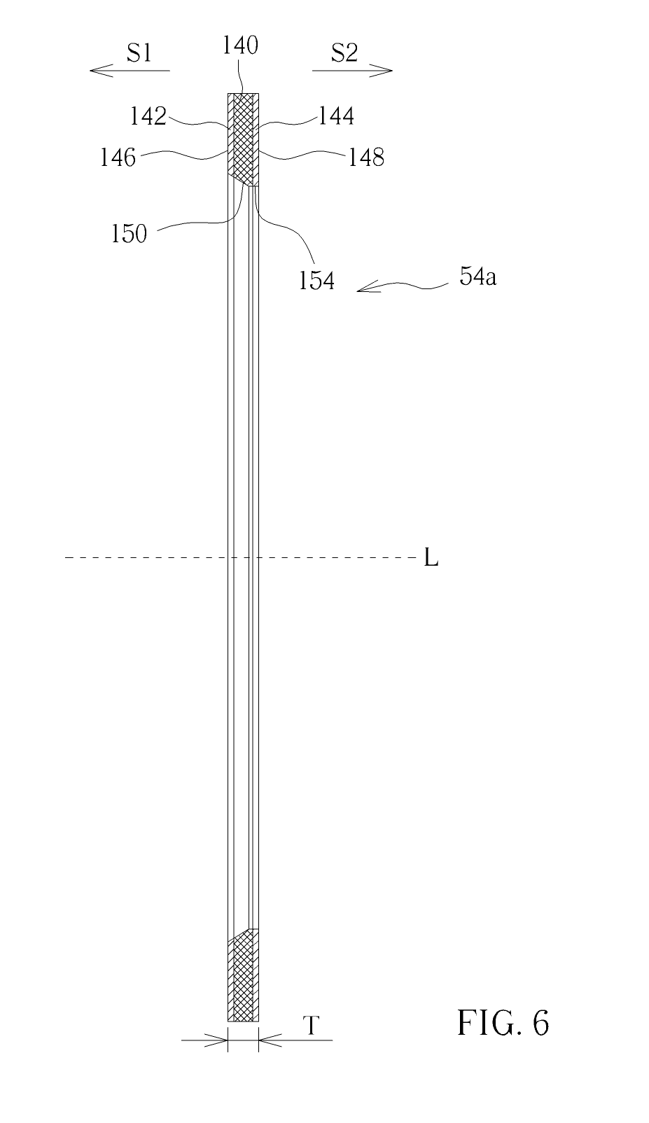

Referring to FIG. 6, FIG. 6 is a cross-sectional view illustrating a spacer 54a according to a fifth embodiment of the invention. The main difference between the spacer 54a and the aforesaid spacer 14a is that the spacer 54a further has an inner ring-shaped flat surface 154. As shown in FIG. 6, the first inner ring-shaped oblique surface 150 and the inner ring-shaped flat surface 154 both are formed at the inner periphery of the spacer 54a, the inner ring-shaped flat surface 154 is connected to the first inner ring-shaped oblique surface 150, and the inner ring-shaped flat surface 154 is perpendicular to the object-side surface 146 and the image-side surface 148. In this embodiment, when forming the first inner ring-shaped oblique surface 150 by the stamping process, the spacer 54a may be stamped by a stamping head in front of the inner ring-shaped flat surface 154, so as to prevent an inner hole of the spacer 54a from being expanded due to over-stamping and avoid influencing the optical property of the imaging lens. It should be noted that the same elements in FIG. 6 and FIG. 2 are represented by the same numerals, so the repeated explanation will not be depicted herein again. Furthermore, the structure of each spacer 14b, 14c may be the same as that of the spacer 54a according to practical applications.

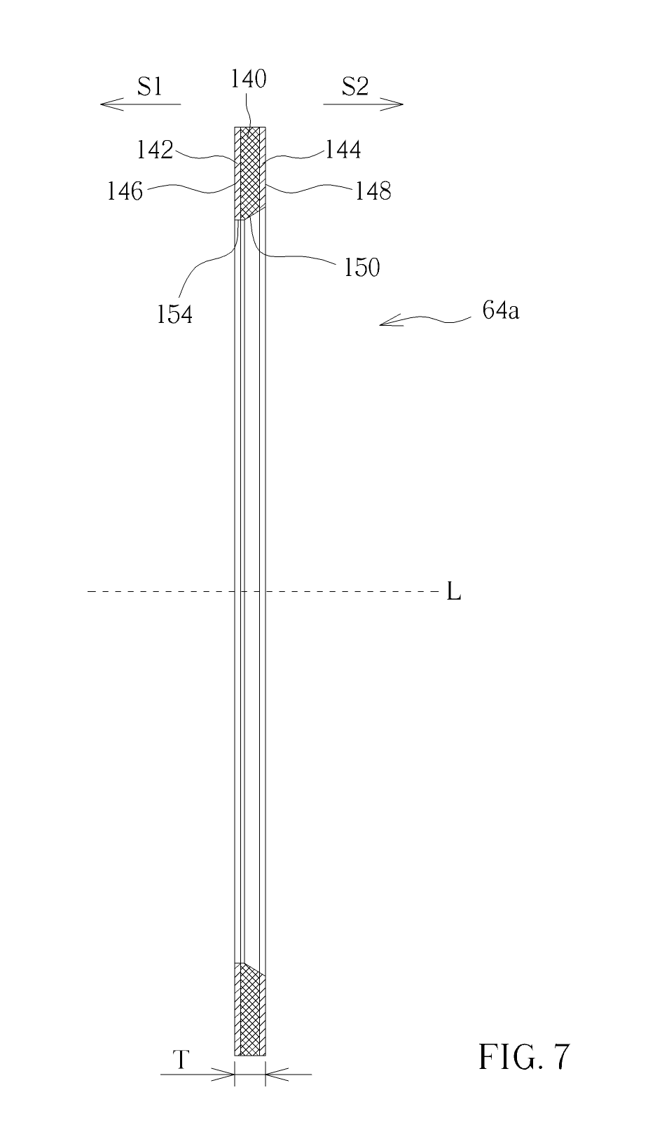

Referring to FIG. 7, FIG. 7 is a cross-sectional view illustrating a spacer 64a according to a sixth embodiment of the invention. The main difference between the spacer 64a and the aforesaid spacer 54a is that an inclined direction of the first inner ring-shaped oblique surface 150 of the spacer 64a is opposite to an inclined direction of the first inner ring-shaped oblique surface 150 of the spacer 54a. It should be noted that the same elements in FIG. 7 and FIG. 6 are represented by the same numerals, so the repeated explanation will not be depicted herein again. Furthermore, the structure of each spacer 14b, 14c may be the same as that of the spacer 64a according to practical applications.

As mentioned in the above, the invention attaches two outside layers with better anti-reflection capability on opposite sides of the inside layer, respectively, so as to form a three-layer spacer, and forms at least one inner ring-shaped oblique surface at the inner periphery of the three-layer spacer. When light emitted or reflected by an object, which is located at the object side of the imaging lens, enters the lens barrel, the two outside layers and the inner ring-shaped oblique surface can restrain the light from being reflected by the inner periphery of the spacer effectively, so as to avoid the occurrence of flare or ghost phenomenon.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An imaging lens comprising:
a lens barrel;
a plurality of lens elements disposed in the lens barrel; and
a spacer disposed between the lens barrel and one of the lens elements or between two adjacent lens elements, the spacer being ring-shaped and comprising an inside layer and two outside layers, the two outside layers being attached on opposite sides of the inside layer, respectively, an anti-reflection capability of at least one of the two outside layers being better than an anti-reflection capability of the inside layer, an outer periphery of the spacer extending to contact an inner wall of the lens barrel.

2. The imaging lens of claim 1, wherein the anti-reflection capability of the outside layer better than the anti-reflection capability of the inside layer is oriented toward an object side of the lens elements.

3. The imaging lens of claim 1, wherein the anti-reflection capability of the outside layer better than the anti-reflection capability of the inside layer is oriented toward an image side of the lens elements.

4. The imaging lens of claim 1, wherein the anti-reflection capability of each outside layer is better than the anti-reflection capability of the inside layer.

5. The imaging lens of claim 1, wherein the spacer has an object-side surface, an image-side surface and a first inner ring-shaped oblique surface, the object-side surface and the image-side surface are formed outside the two outside layers in parallel and oriented toward an object side and an image side of the lens elements, respectively, the first inner ring-shaped oblique surface is formed at an inner periphery of the spacer and connected to at least one of the object-side surface and the image-side surface.

6. The imaging lens of claim 5, wherein an internal diameter of the spacer increases gradually along the first inner ring-shaped oblique surface from the object side to the image side.

7. The imaging lens of claim 5, wherein an internal diameter of the spacer increases gradually along the first inner ring-shaped oblique surface from the image side to the object side.

8. The imaging lens of claim 5, wherein the spacer further has a second inner ring-shaped oblique surface, the second inner ring-shaped oblique surface is formed at the inner periphery of the spacer, the first inner ring-shaped oblique surface is connected between the object-side surface and the second inner ring-shaped oblique surface, and the second inner ring-shaped oblique surface is connected between the image-side surface and the first inner ring-shaped oblique surface.

9. The imaging lens of claim 5, wherein the spacer further has an inner ring-shaped flat surface, the inner ring-shaped flat surface is formed at the inner periphery of the spacer and connected to the first inner ring-shaped oblique surface, and the inner ring-shaped flat surface is perpendicular to the object-side surface and the image-side surface.

10. The imaging lens of claim 5, wherein the first inner ring-shaped oblique surface is formed at the inner periphery of the spacer by a stamping process.

11. The imaging lens of claim 5, wherein a thickness of the spacer at the first inner ring-shaped oblique surface decreases gradually toward an optical axis of the lens elements.

12. The imaging lens of claim 1, wherein the inside layer is made of a polymer material and the two outside layers are made of a carbon material.

13. An imaging lens comprising:
a lens barrel;
a plurality of lens elements disposed in the lens barrel; and
a spacer disposed between the lens barrel and one of the lens elements or between two adjacent lens elements, the spacer having an object-side surface, an image-side surface and a first inner ring-shaped oblique surface, the object-side surface and the image-side surface being formed outside the two outside layers in parallel and oriented toward an object side and an image side of the lens elements, respectively, the first inner ring-shaped oblique surface being formed at an inner periphery of the spacer and connected to at least one of the object-side surface and the image-side surface, an outer periphery of the spacer extending to contact an inner wall of the lens barrel.

14. The imaging lens of claim 13, wherein an internal diameter of the spacer increases gradually along the first inner ring-shaped oblique surface from the object side to the image side.

15. The imaging lens of claim 13, wherein an internal diameter of the spacer increases gradually along the first inner ring-shaped oblique surface from the image side to the object side.

16. The imaging lens of claim 13, wherein the spacer further has a second inner ring-shaped oblique surface, the second inner ring-shaped oblique surface is formed at the inner periphery of the spacer, the first inner ring-shaped oblique surface is connected between the object-side surface and the second inner ring-shaped oblique surface, and the second inner ring-shaped oblique surface is connected between the image-side surface and the first inner ring-shaped oblique surface.

17. The imaging lens of claim 13, wherein the spacer further has an inner ring-shaped flat surface, the inner ring-shaped flat surface is formed at the inner periphery of the spacer and connected to the first inner ring-shaped oblique surface, and the inner ring-shaped flat surface is perpendicular to the object-side surface and the image-side surface.

18. The imaging lens of claim 13, wherein the first inner ring-shaped oblique surface is formed at the inner periphery of the spacer by a stamping process.

19. The imaging lens of claim 13, wherein a thickness of the spacer at the first inner ring-shaped oblique surface decreases gradually toward an optical axis of the lens elements.
